(19) United States
(12) Patent Application Publication
(10) Pub. No.: US 2023/0266607 A1
(43) Pub. Date: Aug. 24, 2023

(54) SMART GLASSES APPARATUS AND SMART HINGE ASSEMBLY

(71) Applicant: SOLOS TECHNOLOGY (SHENZHEN) LIMITED, Shenzhen (CN)

(72) Inventors: Wai Kuen Cheung, Shenzhen (CN); Chiu Ming So, Shenzhen (CN); Chiu Kan Tsang, Shenzhen (CN); Mei Sze Au-Yeung, Shenzhen (CN); Kwok Wah Law, Shenzhen (CN)

(21) Appl. No.: 18/166,475

(22) Filed: Feb. 8, 2023

(30) Foreign Application Priority Data
Feb. 18, 2022 (CN) 202210152389.6

(51) Int. Cl. G02C 5/22; G02C 11/00

(52) U.S. Cl. CPC G02C 5/22; G02C 11/10

(57) ABSTRACT

The present invention provides a smart glasses apparatus and a smart hinge assembly thereof. The smart glasses apparatus further includes first and two second components. Different second components have different types of interfaces. The smart hinge assembly includes at least two smart hinges which are different in interface types and used in an alternative manner. Each smart hinge includes a first end for hinging with the first component and a second end for plugging with the second component. The second ends of different smart hinges are equipped with connectors of different interface types, the interface types of the connectors match with the interface types of the second components. The smart hinges are hinged to the first component in an alternative manner, and the second components plug with the smart hinges in an alternative manner. The first component is electrically connected to the second components through the smart hinges.

### CROSS-REFERENCE TO RELATED APPLICATIONS

The present application claims priority of Chinese Patent Application No. 202210152389.6, filed on Feb. 18, 2022, the entire contents of which are hereby incorporated by reference.

### TECHNICAL FIELD

The present invention relates to the technical field of smart wearable apparatus, and in particular to a smart glasses apparatus and a smart hinge assembly.

### BACKGROUND

With the development of wearable technology, smart wearable apparatus, such as smart glasses, are used more widely. However, some questions need to be improved are also exposed during in use.

For existing smart wearable apparatus (such as smart glasses), the front is assembled with the temples which are designed originally through smart hinges after the glasses accessories are produced. Because the connectors provided on the temples are different, the interfaces thereof for connecting the hinges are also different. Therefore, the smart hinge can only install a connector that matches with the connector of the temple, which leads to one kind of front can only correspond to one kind of temple, limiting the flexible switching of product functions.

Thus, it is necessary to provide a new type of smart hinge structure so that the front with different smart hinges can be interchanged with the temples with different functions to provide different smart functions.

### SUMMARY

The present invention provides a smart glasses apparatus and a smart hinge assembly to solve the technical problem that the accessories of the smart wearable apparatus in the prior art can only be assembled one-to-one and thus switching of product functions is inflexible.

The present invention is realized by a smart hinge assembly which is configured for interconnecting a first component and a second component of a smart wearable apparatus. The smart hinge assembly includes at least two smart hinges which are different in interface types and used in an alternative manner. Each smart hinge includes a first end for hinging with the first component and a second end for plugging with the second component. The second ends of different smart hinges are equipped with connectors of different interface types, the interface types of the connectors match with the interface types of the second components.

In some embodiments, each smart hinge includes an insulating shell, a circuit board and the connector; the circuit board is mounted in the insulating shell and electrically connected to the connector; a first end of the insulating shell is configured for hinging with the first component, a second end of the insulating shell is configured for plugging with the second component; and a locking portion is formed at the second end of the insulating shell for connecting the second component by snap-fitting.

In some embodiments, a connecting hole is defined in the first end of the insulating shell, and the first end of the insulating shell is hinged to the first component by a mounting shaft which is inserted into the connecting hole.

In some embodiments, the connector is soldered on the circuit board, and different types of connectors include a USB Type-C connector and a PogoPin connector.

In some embodiments, a sensor and a wireless communication module are soldered on the circuit board, and the sensor includes an ultraviolet sensor and an environmental particle sensor for detecting the content of particles in the environment.

In some embodiments, the insulating shell includes a cantilever, and the locking portion is an external locking portion which is formed on the cantilever and protrudes out from a top surface of the cantilever.

In some embodiments, the insulating shell includes a chamber, and the locking portion is an internal locking portion which is formed on an inner wall of the chamber and protrudes out from the inner wall of the chamber.

In some embodiments, the insulating shell includes a plastic shell body and a sealing cover, the circuit board is mounted in a mounting groove defined in the plastic shell body, the sealing cover covers and seals the mounting groove, and a gap between the circuit board and the mounting groove is filled with waterproof glue.

In some embodiments, a material of the insulating shell is a light-transmitting material.

In order to solve the technical problem, this embodiment further provides a smart glasses apparatus which includes at least one first component, at least two second components and the above smart hinge assembly. A number of the smart hinges of the smart hinge assembly is the same as a number of the second components. Different second components have different types of interfaces. The smart hinges of different interface types are hinged to the first component in an alternative manner, and the interfaces of the different second components plug with the smart hinges in an alternative manner. The first component is electrically connected to the second components through the smart hinges.

In some embodiments, the first component is a front of the smart glasses apparatus, the second component is a temple of the smart glasses apparatus, the first end of the smart hinge is hinged to the front by a mounting shaft, and the second end of the smart hinge plugs with the temple and is locked with the temple by a snap-fitting structure.

In some embodiments, an MCU and a first wireless communication module are mounted in the temple, and a second wireless communication module is mounted in the smart hinge; the second wireless communication module is configured for communicating with a mobile phone to realize interaction between the smart hinge and the mobile phone; the second wireless communication module is further configured for communicating with the first wireless communication module to realize interaction between the smart hinge and the MCU in the temple; and the first wireless communication module is further configured for communicating with the mobile phone to realize interaction between the MCU in the temple and the mobile phone.

In some embodiments, when the first wireless communication module and second wireless communication module both can establish communication with the mobile phone, the temple and the smart hinge send the obtained relevant data to the mobile phone; and when the first wireless communication module and second wireless communication module cannot establish communication with the mobile phone, the first wireless communication module establishes communication with the second wireless communication module, and the smart hinge sends the obtained relevant data to the MCU in the temple.

In some embodiments, a connecting portion of the temple and smart hinge is surrounded with a sealing ring, and a front wall of the second end of the smart hinge abuts against the sealing ring when the smart hinge and the temple are connected by plugging.

Compared with the prior art, the present invention has the advantages of:

In terms of structural connection, the smart hinge assembly of the present invention includes at least two smart hinges, different smart hinges are equipped with connectors of different interface types (may be USB Type-C connector, PogoPin connector or connectors of other interface types), and the second end of the smart hinge is connected to the second component by plugging. Since plugging is detachable connection, the first component and second component of different generations or styles can be interchanged, people may upgrade their smart glasses with the latest accessories, and thus the functions of the product can be switched flexibly.

In terms of electrical connection, the smart hinge and the first component can be electrically connected by means of board to board connectors, welding wires, etc. The connector for electrically connecting the smart hinge and second component may be USB Type-C connector, PogoPin connector, or connectors of other interface types. The smart hinge assembly of the present invention allows the use of connectors of different interface types to connect accessories of different functions.

### BRIEF DESCRIPTION OF THE DRAWINGS

FIG. 1 is a schematic view of a smart hinge equipped with a USB Type-C connector according to an embodiment of the present invention.

FIG. 2 is a schematic view of a smart hinge equipped with a PogoPin connector according to an embodiment of the present invention.

FIG. 3 is a schematic, exploded view of a smart hinge equipped with a PogoPin connector according to an embodiment of the present invention.

FIG. 4 is a schematic, assembled view of a smart hinge equipped with a USB Type-C connector and a corresponding temple according to an embodiment of the present invention.

FIG. 5 is a schematic, assembled view of a smart hinge equipped with a PogoPin connector and a corresponding temple according to an embodiment of the present invention.

FIG. 6 is a schematic view of a temple equipped with a USB Type-C connector according to an embodiment of the present invention.

FIG. 7 is a schematic view of a temple equipped with a PogoPin connector according to an embodiment of the present invention.

FIG. 8 is a schematic, exploded view of a smart hinge equipped with a PogoPin connector and a front according to an embodiment of the present invention.

FIG. 9 is a schematic, assembled view of a smart hinge equipped with a PogoPin connector and a front according to an embodiment of the present invention.

FIG. 10 is an exploded, cross sectional view of a smart hinge equipped with a USB Type-C connector and a temple according to an embodiment of the present invention.

FIG. 11 is a schematic, exploded view of a smart hinge equipped with a USB Type-C connector and a temple according to an embodiment of the present invention.

FIG. 12 is a schematic, exploded view of a smart glasses apparatus according to an embodiment of the present invention.

FIG. 13 shows electrical connection between a front and a smart hinge according to an embodiment of the present invention.

FIG. 14 shows an electric wire in a front of a smart glasses apparatus according to an embodiment of the present invention.

### DESCRIPTION OF THE EMBODIMENTS

For better illustrating the objects, technical solutions and advantages of the present invention, detailed description will be given for the embodiments provided by the present invention with reference to the append drawings. Obviously, the described specific embodiments are only used to explain the present invention, not to limit the present invention.

In the description of the present invention, it should be noted that, the oriental or positional relationships indicated by the terms “center”, “top”, “bottom”, “left”, “right”, “vertical”, “horizontal”, “inner”, “outer” and the like are only intended to facilitate the description of the present invention and simplify the description based on oriental or positional relationships shown in the accompanying drawings, not to indicate or imply that the apparatus or element referred must have a specific orientation, is constructed and operated in a specific orientation, and therefore cannot be understood as a limitation of the present invention. The terms “first”, “second” and “third” are only used for descriptive purposes, and cannot be understood as indicating or implying relative importance or implicitly indicating the number of technical features indicated. In addition, unless otherwise specified and limited, the terms “mount”, “interconnect”, and “connect” should be understood in a broad sense. For example, “connect” may be fixedly, detachably, or integrally as one piece; “connect” also may be directly or indirectly through an intermediate member, “connect” further may be internal communication of two members. The specific meanings of the above-mentioned terms in the present invention can be specifically understood by persons of ordinary skill in the art.

In this embodiment, a smart hinge assembly is provided for interconnecting a first component and a second component of a smart wearable apparatus. The smart hinge assembly includes at least two smart hinges which are different in interface types and used in an alternative manner. Each smart hinge includes a first end configured for hinging with the first component and a second end configured for plugging with the second component to form a snap-fitting connection.

In order to facilitate the description of the technical solution of this embodiment, the detailed description below for this embodiment takes the smart hinge of the smart glasses as an example, wherein the first component is a front of the smart glasses, and the second component is a temple of the smart glasses.

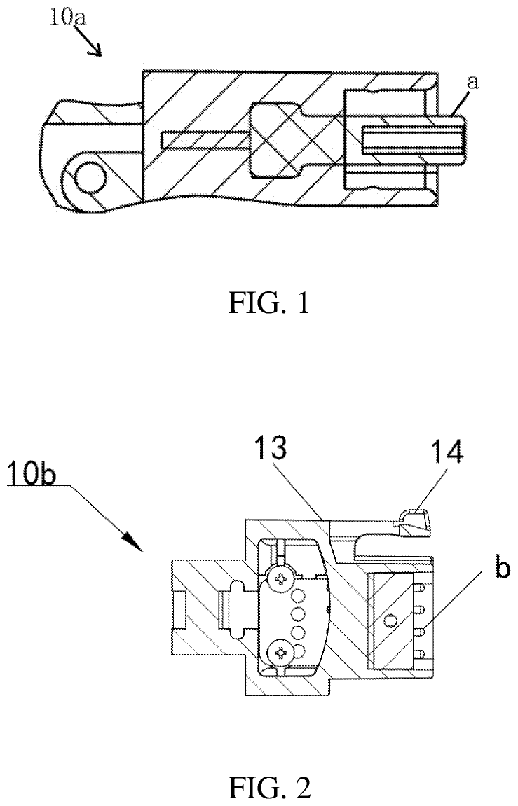

Referring to FIG. 1 and FIG. 2, the two smart hinges respectively equipped with connectors of different interface types are shown. The interface type of the connector of each smart hinge corresponds to the interface type of the temple mating with the connector. As shown in FIG. 1, the connector mounted on the smart hinge 10a is a USB Type-C connector a. As shown in FIG. 2, the connector mounted on the smart hinge 10b is a Pogopin connector b. Of course, these may be connectors of other interface types, which are not described in detail herein.

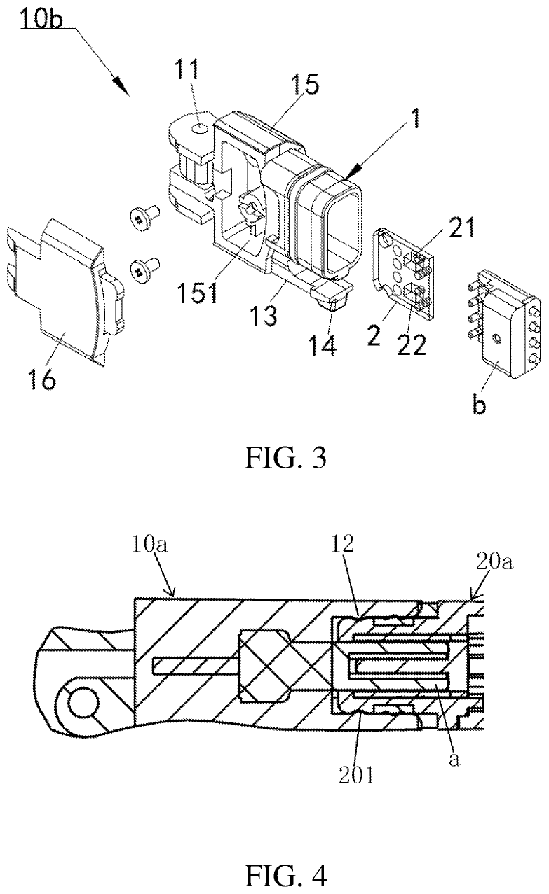

Referring to FIG. 3, the smart hinge 10b equipped with the pogopin connector is shown. The smart hinge 10b includes an insulating shell 1, a circuit board 2 and the pogopin connector b. The circuit board 2 is mounted in the insulating shell 1. The Pogopin connector b is soldered on and electrically connected to the circuit board 2. The circuit board 2 is also soldered with a sensor 21 and a wireless communication module 22. A type of the sensor 21 can be flexibly set according to needs, for example, it may include an ultraviolet sensor and an environmental particle sensor for detecting the content of particles in the environment. The wireless communication module 22 may be a BLE low power consumption Bluetooth, a Bluetooth, a WIFI wireless network, etc., which is mounted in the smart hinge 10b and transmits the data obtained by the sensor 21 to a wireless chip in the temple or to a mobile phone of the user by wireless communication. In order to facilitate the sensor 21 to receive or transmit signals, a material of the insulating shell 1 of this embodiment is a light-transmitting material. The hardware in the smart hinge 10b is separated from the hardware in the temple, which has the advantage that the hardware of the main PCB board of the temple does not need to be modified.

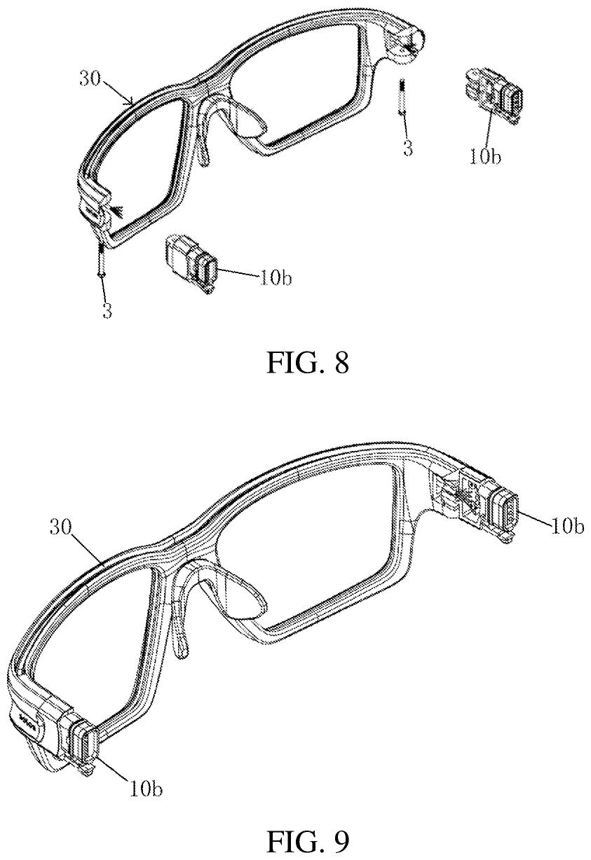

Please referring to FIG. 8 together, a connecting hole 11 is defined in a first end of the insulating shell 1, and the first end of the insulating shell 1 is hinged to the front by inserting a mounting shaft 3 (such as a screw) into the connecting hole 11. Thus, the smart hinge can rotate relative to the front to realize relative rotation of the temple and the front.

A second end of the insulating shell 1 is configured for plugging with the temple, and a locking portion is formed at the second end of the insulating shell 1 for connecting the temple by snap-fitting. Through the plug-in structure, the smart hinge and the temple are easy to assemble and disassemble, and the addition of the snap-fitting connection structure can ensure that the smart hinge and the temple are connected firmly.

Please referring to FIG. 1 and FIG. 4, the insulating shell 1 of the smart hinge 10a includes a chamber 10, and the locking portion is an internal locking portion 12 which is formed on an inner wall of the chamber 10 and protrudes out from the inner wall of the chamber 10. After the smart hinge 10a and the temple 20a are connected by plugging, the internal locking portion 12 is capable of engaging into a concave portion 201 of the temple 20a, thereby locking the smart hinge 10a to the temple 20a firmly.

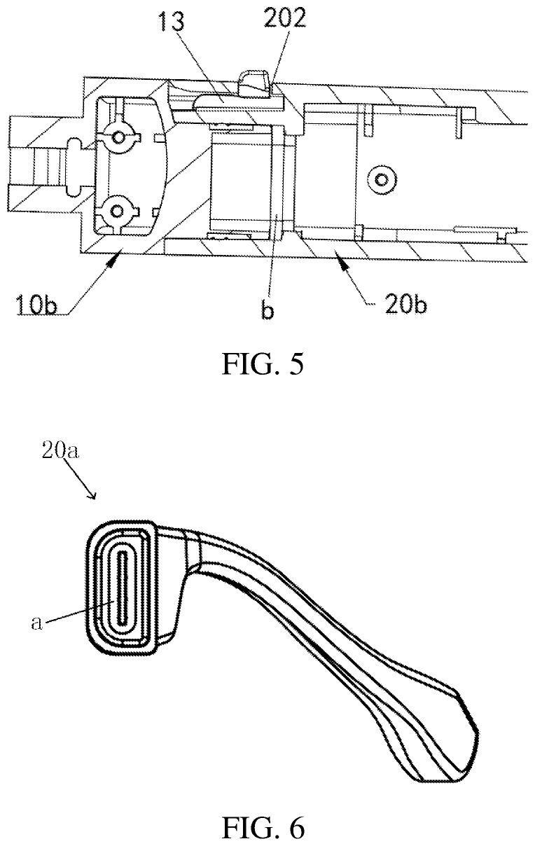

Please referring to FIG. 2 and FIG. 5, the insulating shell 1 of the smart hinge 10b includes a cantilever 13. The locking portion is an external locking portion 14, which is formed on the cantilever 13 and protrudes out from a top surface of the cantilever 13. After the smart hinge 10a and the temple 20a are connected by plugging, the cantilever 13 extends into the temple 20b and engages into a concave portion 202 of the temple 20b, thereby locking the smart hinge 10b to the temple 20b firmly.

Specifically, as shown in FIG. 3, the insulating shell 1 of the smart hinge 10b includes a plastic shell body 15 and a sealing cover 16. The circuit board 2 is mounted in a mounting groove 151 defined in the plastic shell body 15, and the sealing cover 16 covers and seals the mounting groove 151. A gap between the circuit board 2 and the mounting groove 151 is filled with waterproof glue, which prevents water from entering the smart hinge 10b or entering the temple 20b through the smart hinge 10b. Similarly, the smart hinge 10a is designed to have the same sealing structure and filled with waterproof glue too, which is not described in detail herein.

In this embodiment, a smart glasses apparatus is further provided. The smart glasses apparatus includes at least one first component, at least two second components, and the smart hinge assembly. Different second components are provided with different types of interfaces. The smart hinges with different interface types are hinged to the first component in an alternative manner. Different second components are connected to the smart hinges in an alternative manner. The first component is electrically connected to the second components through the smart hinges.

The electrical connection between the smart hinge and the first component may be made by means of a board-to-board connector, a soldering wire, and etc. The connector used for electrically connecting the smart hinge to the second component may be the USB Type-C connector a, the PogoPin connector b, or a connector of other interface type. The smart hinge assembly of this embodiment allows the use of different connectors to connect the accessories of different functions of the smart apparatus.

Specifically, the smart glasses apparatus of this embodiment includes a front, two temples and a smart hinge assembly. The smart hinge assembly includes two smart hinges with connectors of different interface types. The two temples are provided with different types of interfaces, respectively.

An MCU and a first wireless communication module are mounted in the temple, and a second wireless communication module is mounted in the smart hinge. The second wireless communication module is configured to communicate with a mobile phone to realize interaction between the smart hinge and the mobile phone. The second wireless communication module is further configured to communicate with the first wireless communication module to realize interaction between the smart hinge and the MCU in the temple. The first wireless communication module is further configured to communicate with the mobile phone to realize interaction between the MCU in the temple and the mobile phone.

Specifically, when the first wireless communication module and second wireless communication module both can establish communication with the mobile phone, both the temple and the smart hinge send the obtained relevant data to the mobile phone, so that the mobile phone can perform calculation and control according to the received relevant data. In this situation, the mobile phone functions as a master device, and the temples and smart hinges function as slave devices. The data obtained by the smart hinge may be data of the ultraviolet sensor, data of the environmental particle sensor, and etc. The data obtained by the temple may be data of a Nine-axis sensor, data of a touch sensor, data of a proximity sensor, and etc. The Nine-axis sensor, the touch sensor, and the proximity sensor all are arranged in the temple. The data of the Nine-axis sensor may reflect the user's head pose. The touch sensor is used to sense the user's touch operation. The proximity sensor is used to detect whether the user wears or removes the smart glasses and obtain a time period for which the user wears/removes the smart glasses.

When the first wireless communication module and second wireless communication module cannot establish communication with the mobile phone (such as the user does not carry the mobile phone), the first wireless communication module establishes communication with the second wireless communication module, so that the smart hinge sends the obtained relevant data to the MCU in the temple, which is convenient for the MCU in the temple to perform relevant data calculation. In this situation, the temple functions as a master device, while the smart hinge functions as a slave device.

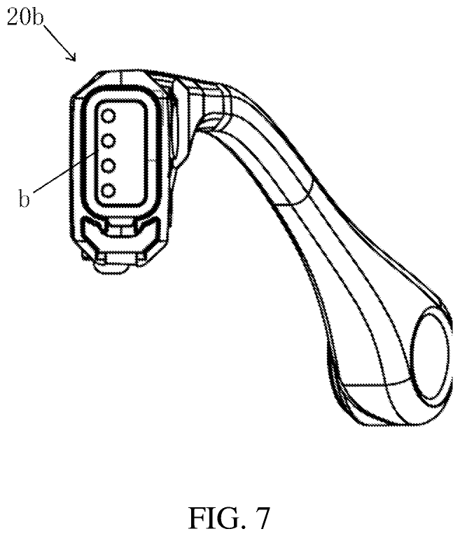

In this embodiment, as shown in FIG. 6, one of the temples 20a is provided with a USB Type-C connector a; and the other temple 20b is provided with a PogoPin connector b, as shown in FIG. 7.

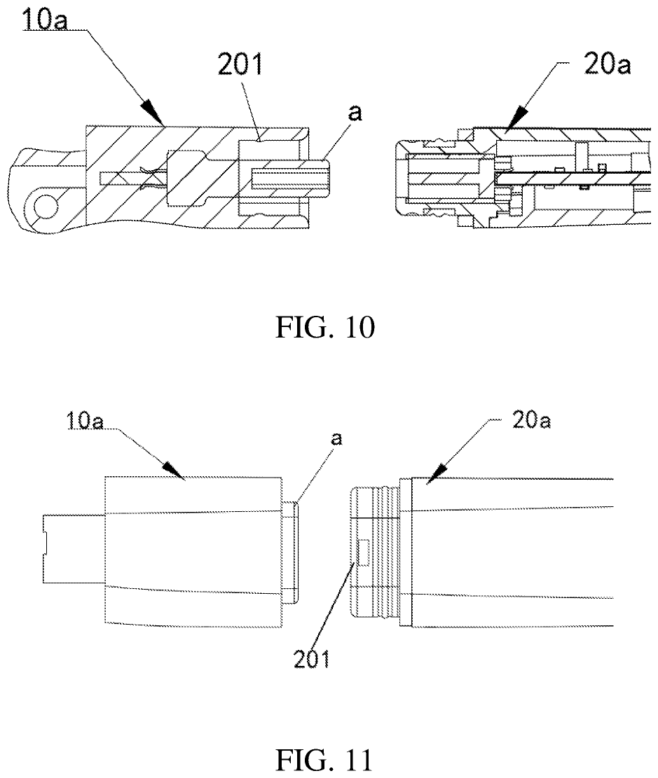

The two smart hinges are hinged to the front by the mounting shaft in an alternative way. As shown in FIGS. 8 and 9, which show that the smart hinge 10b with the PogoPin connector b is hinged to the front 30 by the mounting shaft 3. The two temples are connected to the smart hinges by plugging in an alternative way. As shown in FIGS. 10 and 11, which show that the temple 20a with the USB Type-C connector a and the smart hinge 10a are connected together by plugging.

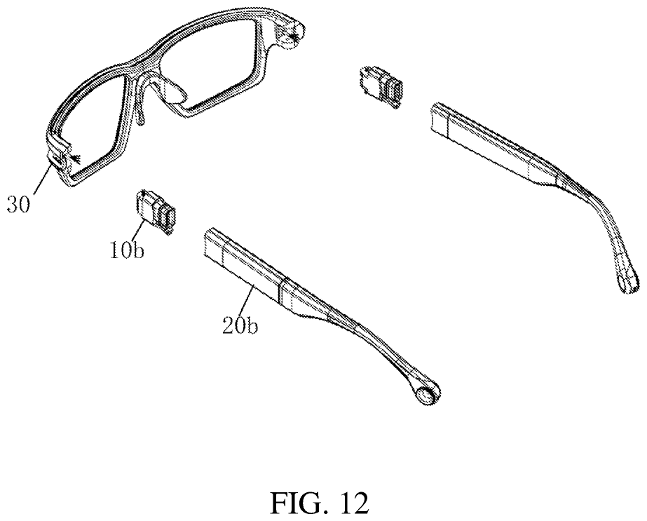

Please referring to FIG. 12, since the smart hinge 10b and the temple 20b are detachably connected by plugging, the front 30 and the temple 20b of different generations or styles can be interchanged. People may upgrade their smart glasses with the latest front 30 and temple 20b, for example, the temples 20b may be replaced from the first generation to the second or third generation while the front 30 is unchanged, i.e., people may upgrade their smart glasses with the latest temples 20b without replacing the front 30 with prescription lenses. People may also use the same leg 20b but replace the frame 30 of different styles, that is, the leg 20b is capable of matching the frame 30 of the fashionable blue light glasses for working, and matching the frame 30 of the sun glasses for sports or outdoors. The functions of the product can be switched flexibly.

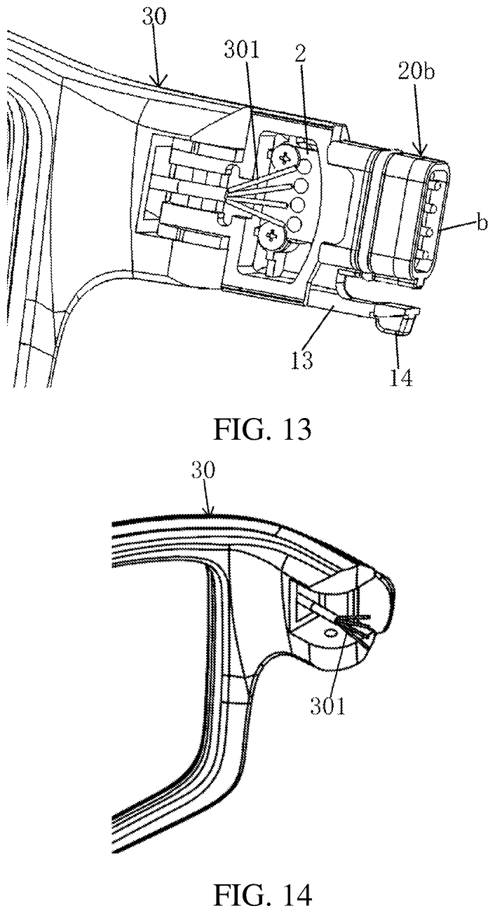

Please referring to FIG. 13, the electronic circuits in the front 30 are soldered to the circuit board 2 in the smart hinge 10b through electric wires. An end of the temple 20b adjacent to the smart hinge 10b is provided with a connector 203b matching with the Pogopin connector b.

As shown in FIG. 14, there is an electric wire 301 embedded in the front 30. The electric wire 301 connects the left side to right side electrically, and may be a FPC (flexible printed circuit), a four-core enameled wire, an eight-core enameled wire, and etc. The left temple has a battery embedded therein for providing power to the smart glasses, and the right temple has electronic components such as MCU, sensors, Bluetooth chips embedded therein for achieving the functions of the smart glasses.

Further, as shown in FIG. 4, in order to enhance the waterproof and dustproof performance, a connecting portion of the temple 20a and smart hinge 10a is enclosed with a sealing ring 4. When the smart hinge 10a and the temple 20a are connected by plugging, a front wall of the second end of the smart hinge abuts against the sealing ring 4. In practical application, soft glue is injected to the hard rubber shell of the temple 20a by secondary injection molding to form the sealing ring 4. After the temple 20a is inserted into the smart hinge 10a, a port at the second end of the plastic shell body 15 presses the sealing ring 4, so that the connecting portion can achieve a waterproof of IPX6/7. The connecting portion is completely sealed, so as to prevent water and dust from entering the temple 20a, thereby realizing the function of waterproof and dustproof. Similarly, a connecting portion of the temple 20b and smart hinge 10b is surrounded by a sealing ring 4, which will not be described in detail herein.

The above merely describes preferred embodiments of the present invention without intention to limit the scope of the present invention. Any modifications, equivalent changes, improvements, and etc. made within the spirit and principle of the present invention should be within the scope of the present invention.

What is claimed is:

1. A smart hinge assembly, configured for interconnecting a first component and a second component of a smart wearable apparatus, comprising:
at least two smart hinges which are different in interface types and used in an alternative manner, each smart hinge comprising a first end configured for hinging with the first component and a second end configured for plugging with the second component, the second ends of different smart hinges being equipped with connectors of different interface types, the interface types of the connectors matching with the interface types of the second components.

2. The smart hinge assembly according to claim 1, wherein each smart hinge comprises an insulating shell, a circuit board and the connector; the circuit board is mounted in the insulating shell and electrically connected to the connector; a first end of the insulating shell is configured for hinging with the first component, a second end of the insulating shell is configured for plugging with the second component; and a locking portion is formed at the second end of the insulating shell for connecting the second component by snap-fitting.

3. The smart hinge assembly according to claim 2, wherein a connecting hole is defined in the first end of the insulating shell, and the first end of the insulating shell is hinged to the first component by a mounting shaft which is inserted into the connecting hole.

4. The smart hinge assembly according to claim 2, wherein the connector is soldered on the circuit board, and different types of connectors comprise a USB Type-C connector and a PogoPin connector.

5. The smart hinge assembly according to claim 2, wherein a sensor and a wireless communication module are soldered on the circuit board, and the sensor comprises an ultraviolet sensor and an environmental particle sensor for detecting the content of particles in the environment.

6. The smart hinge assembly according to claim 2, wherein the insulating shell comprises a cantilever, and the locking portion is an external locking portion which is formed on the cantilever and protrudes out from a top surface of the cantilever.

7. The smart hinge assembly according to claim 2, wherein the insulating shell comprises a chamber, and the locking portion is an internal locking portion which is formed on an inner wall of the chamber and protrudes out from the inner wall of the chamber.

8. The smart hinge assembly according to claim 2, wherein the insulating shell comprises a plastic shell body and a sealing cover, the circuit board is mounted in a mounting groove defined in the plastic shell body, the sealing cover covers and seals the mounting groove, and a gap between the circuit board and the mounting groove is filled with waterproof glue.

9. The smart hinge assembly according to claim 2, wherein a material of the insulating shell is a light-transmitting material.

10. A smart glasses apparatus, comprising:
at least one first component, at least two second components and the smart hinge assembly according to claim 1,
different second components having different types of interfaces,
the smart hinges of different interface types being hinged to the first component in an alternative manner,
the interfaces of the different second components plugging with the smart hinges in an alternative manner; and
the first component being electrically connected to the second components through the smart hinges.

11. The smart glasses apparatus according to claim 10, wherein the first component is a front of the smart glasses apparatus, the second component is a temple of the smart glasses apparatus, the first end of the smart hinge is hinged to the front by a mounting shaft, and the second end of the smart hinge plugs with the temple and is locked with the temple by a snap-fitting structure.

12. The smart glasses apparatus according to claim 11, wherein an MCU and a first wireless communication module are mounted in the temple, and a second wireless communication module is mounted in the smart hinge; the second wireless communication module is configured for communicating with a mobile phone to realize interaction between the smart hinge and the mobile phone; the second wireless communication module is further configured for communicating with the first wireless communication module to realize interaction between the smart hinge and the MCU in the temple; and the first wireless communication module is further configured for communicating with the mobile phone to realize interaction between the MCU in the temple and the mobile phone.

13. The smart glasses apparatus according to claim 12, wherein when the first wireless communication module and second wireless communication module both can establish communication with the mobile phone, the temple and the smart hinge send the obtained relevant data to the mobile phone; and
when the first wireless communication module and second wireless communication module cannot establish communication with the mobile phone, the first wireless communication module establishes communication with the second wireless communication module, and the smart hinge sends the obtained relevant data to the MCU in the temple.

14. The smart glasses apparatus according to claim 11, wherein a connecting portion of the temple and smart hinge is surrounded with a sealing ring, and a front wall of the second end of the smart hinge abuts against the sealing ring when the smart hinge and the temple are connected by plugging.
